(19) United States
(12) Patent Application Publication
(10) Pub. No.: US 2011/0277275 A1
(43) Pub. Date: Nov. 17, 2011

(54) MOTOR VEHICLE HINGE HAVING A PREFERABLY CONTINUOUSLY VARIABLE BRAKE ARRANGEMENT

(76) Inventor: Horst Wilfried Ball, Dingolfing (DE)

(21) Appl. No.: 13/130,640

(22) PCT Filed: Sep. 23, 2009
(86) PCT No.: PCT/DE2009/001346

§ 371 Date: Jul. 28, 2011

(30) Foreign Application Priority Data
Nov. 27, 2008 (DE) 10 2008 059 425.3

(51) Int. Cl. E05D 11/08

(52) U.S. Cl. 16/337

(57) ABSTRACT

The invention relates to a motor vehicle hinge consisting of a first and second hinge wing (2, 3), a hinge pin (4) connecting the first and second hinge wing (2, 3) in a rotary movable manner around a hinge axis (SA), a preferably continuously variable brake arrangement (5), which comprises one braking surface (5.1) provided at least section-wise radially to the hinge axis (SA) and at least one brake body (5.2) interacting with the braking surface (5.1). In an especially preferred embodiment, the braking surface (5.1) is designed as one piece with the first hinge wing (2) and the brake body (5.2) is provided radially at a distance from the hinge axis (SA) and is directly connected with the second hinge wing (3).

### BACKGROUND OF THE INVENTION

The invention relates to a motor vehicle hinge with a continuously variable brake arrangement.

Various embodiments of motor vehicle hinges which are provided for hinged mounting of a motor vehicle door on the vehicle body are known in the art. Such motor vehicle hinges include first and second hinge wings and a hinge pin connecting the first and second hinge wings in a rotary movable manner around a hinge axis, wherein the first hinge wing is connected with the vehicle body and the second hinge wing is connected with the vehicle door. The brake arrangement associated with the motor vehicle hinge makes it possible to hold the first and second hinge wings relative to each other in at least one pre-defined angle position, so that the opened motor vehicle door is held in at least one preferred open position.

DE 201 22 170 U1 discloses a continuously variable door arrester, for motor vehicle doors, in which a brake arrangement is provided radially around a hinge pin and therefore integrated in the vehicle hinge, by means of which (brake arrangement) two hinge legs can be blocked in nearly any position relative to each other. The brake arrangement in this design consists of two interacting conical surface sections, wherein the conical surface sections are pressed together by a spring force. The disadvantage of this design is that the brake arrangement directly adjoins the hinge pin. Due to the unfavorable leverage ratios caused by this, the hinge pin has to receive very high holding forces, which results in excessive twisting of the hinge pin. In addition, the hinge pin must have a pre-defined minimum length for receiving or fastening of the brake arrangement. As a result of this minimum length, the hinge pin is subjected not only to torsional forces, but also to bending torques. Therefore, the hinge pin must be designed to be very solid, which in turn results in a relatively high weight for the hinge unit. Such a solution therefore contradicts the concept of lightweight construction which is gaining popularity in the automotive industry.

Based on the state of the art as described above, it is an object of the invention to present a motor vehicle hinge which has a simple design with respect to construction and manufacturing technology, while at the same time ensuring high operational reliability and a long service life.

### SUMMARY OF THE INVENTION

An essential aspect of the motor vehicle hinge according to the invention is that the braking surface is designed as one piece with the first hinge wing and the brake body is directly connected with the second hinge wing at a radial distance to the hinge axis. Due to the arrangement according to the invention of the preferably elastic brake body between the first hinge wing forming the braking surface and the second hinge wing, namely at a radial distance to the hinge axis, the area of the interaction between the braking surface and the outer surface of the brake body is moved out of the area of the hinge axis, resulting in more favorable torque conditions for the entire motor vehicle hinge. In the motor vehicle hinge according to the invention the friction torques are introduced directly in the interacting hinge wings, so that an additional strain on the hinge pin is avoided.

Especially advantageous is the fact that the radial distance between the hinge axis and the braking surface along the periphery of the braking surface is constant or section-wise constant or variable or section-wise variable. This makes it possible to define an individual braking effect for different rotary positions of the motor vehicle hinge. Depending on the requirements, the braking surface can follow the path of a circular arc with a constant radial distance to the hinge axis or the path can be discontinuous. For example, the radial distance can decrease as the angle of opening the door increases, so that it is at its lowest value at the maximum angle opening. This results in an increasing holding force of the brake arrangement as the angle of opening increases.

The braking surface can also have a stepped course, i.e. the radial distance to the hinge axis can have at least one stepped change. This results essentially in a sudden increase in the braking or holding force of the brake arrangement in case the brake body overruns the stepped change, wherein the braking force for example remains basically constant until the next stepped change of the radial distance is reached.

In a preferred embodiment, the first hinge wing is at least partially dish-shaped with an at least partially curved dish wall surrounding the hinge axis, wherein at least one section of the dish wall is continuously or discontinuously curved around the hinge axis. It is advantageous for the braking surface to be at least partially formed by the inner surface of the curved section of the dish wall.

### BRIEF DESCRIPTION OF THE DRAWINGS

The invention is described in more detail below based on an exemplary embodiment with reference to several drawings, wherein:

FIG. 1 shows a perspective view of the top side of a motor vehicle hinge according to the invention;

FIG. 2 shows a perspective view of the bottom side of the motor vehicle hinge in FIG. 1;

FIG. 3 shows a top view of the hinge dish of the first hinge wing as well as a cross section through the hinge dish along the plane I-I;

FIG. 4 shows a perspective view of the top side of the second hinge wing of the motor vehicle hinge according to the invention;

FIG. 5 shows a cross section through the motor vehicle hinge according to the invention;

FIG. 6 shows a perspective view of an elastic brake body; and

FIG. 7 shows a cross section along the plane II-II in FIG. 5 through the first and second hinge wing receiving the elastic brake body.

### DETAILED DESCRIPTION OF THE INVENTION

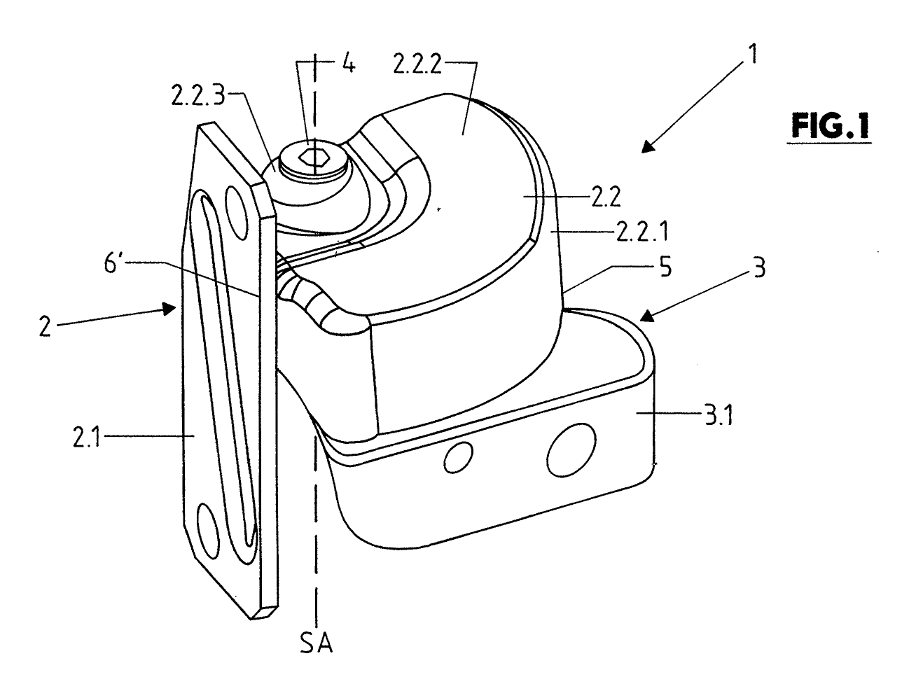

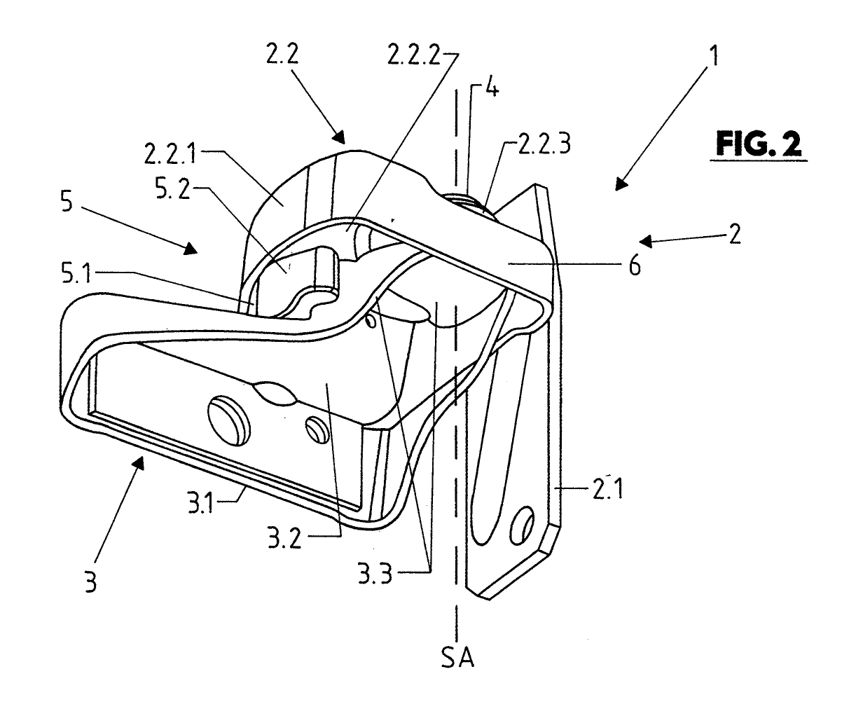

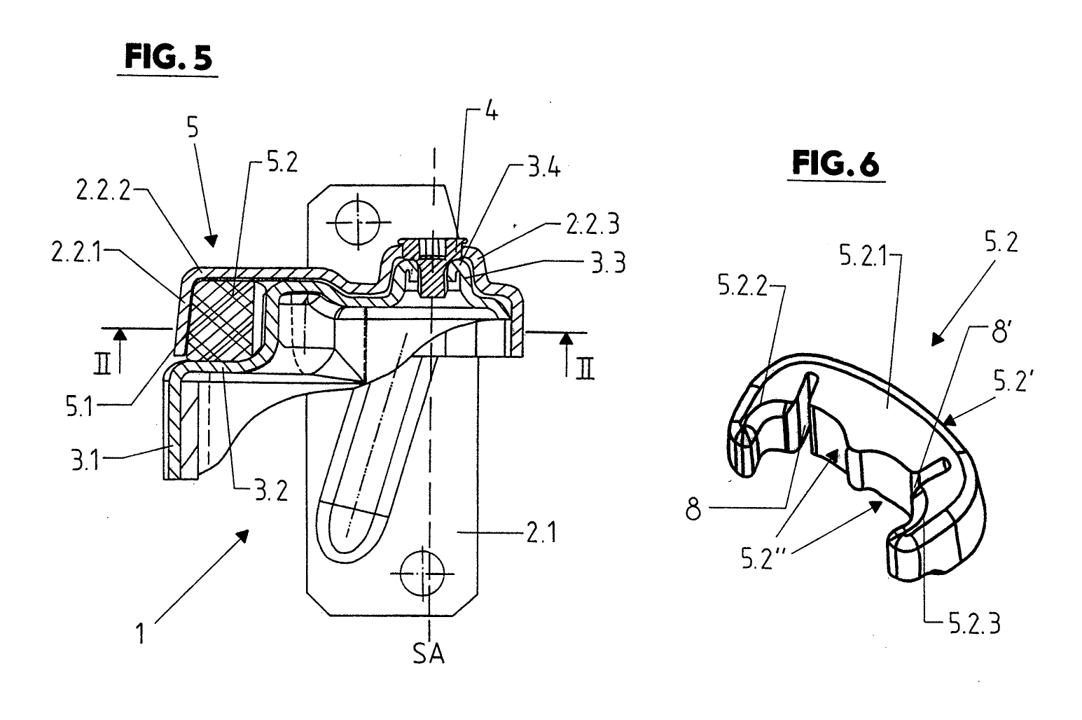

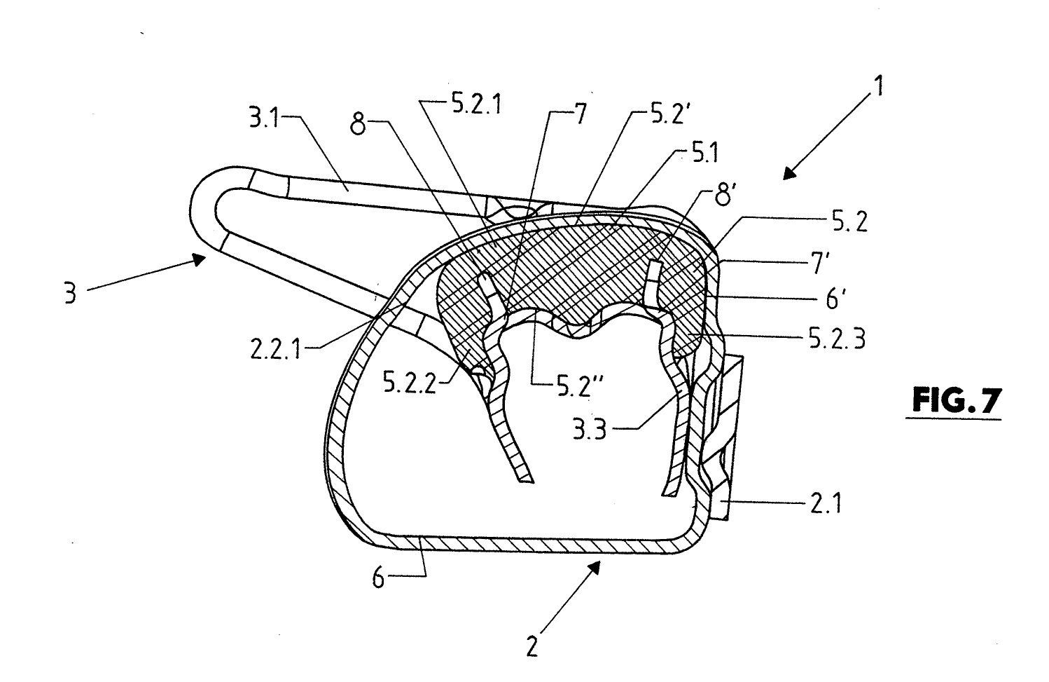

FIGS. 1, 2, 5, and 7 show different views of a motor vehicle hinge 1, according to the invention, with a continuously variable, integrated brake arrangement 5. FIGS. 1 and 2 show the top side and bottom side of the motor vehicle hinge 1 according to the invention in a perspective view. FIG. 5 shows a cross section along the plane I-I and FIG. 7 shows a cross section along plane II-II of the motor vehicle hinge 1 according to the invention.

The motor vehicle hinge 1 has first and second hinge wings 2, 3 which are connected with each other by a hinge pin 4, namely rotatably around a hinge axis SA. The two hinge wings 2, 3 constitute at least partially the preferably continuously variable, integrated brake arrangement 5.

The brake arrangement 5 comprises at least one braking surface 5.1 which extends at least section-wise radially around the hinge axis SA, wherein the radial distance RA between the braking surface 5.1 and the hinge axis SA along the periphery of the braking surface 5.1 can be constant or variable or at least section-wise constant or section-wise variable. To produce a braking effect, an elastic brake body 5.2 is provided which in the case of a pre-defined rotary movement of the first hinge wing 2 relative to the second hinge wing 3 around the hinge axis SA interacts with the braking surface 5.1.

Advantageously, the motor vehicle hinge 1 comprises three components, namely the first and second hinge wings 2, 3 and the brake body 5.2, which can be manufactured easily and with a lightweight design.

In the motor vehicle hinge 1, the braking surface 5.1 is designed as one piece with the first hinge wing 2. Furthermore, the elastic brake body 5.2 is at a radial distance to the hinge axis SA and is directly connected with the second hinge wing 3. The friction torque or braking torque created between the braking surface 5.1 and the elastic brake body 5.2 has a braking effect, controlled by the brake arrangement 5, of a motor vehicle door connected with a vehicle body by means of the motor vehicle hinge 1. In this design the point of origin of the friction torque or braking torque, due to the radial distance RA, is at a distance from the hinge pin 4, so that the generated friction or braking forces are introduced directly into the first and second hinge wings 2, 3, therefore significantly reducing the strain on the hinge pin 4. In particular, the first and second hinge wings 2, 3 are manufactured by means of non-cutting processes, especially by deep drawing.

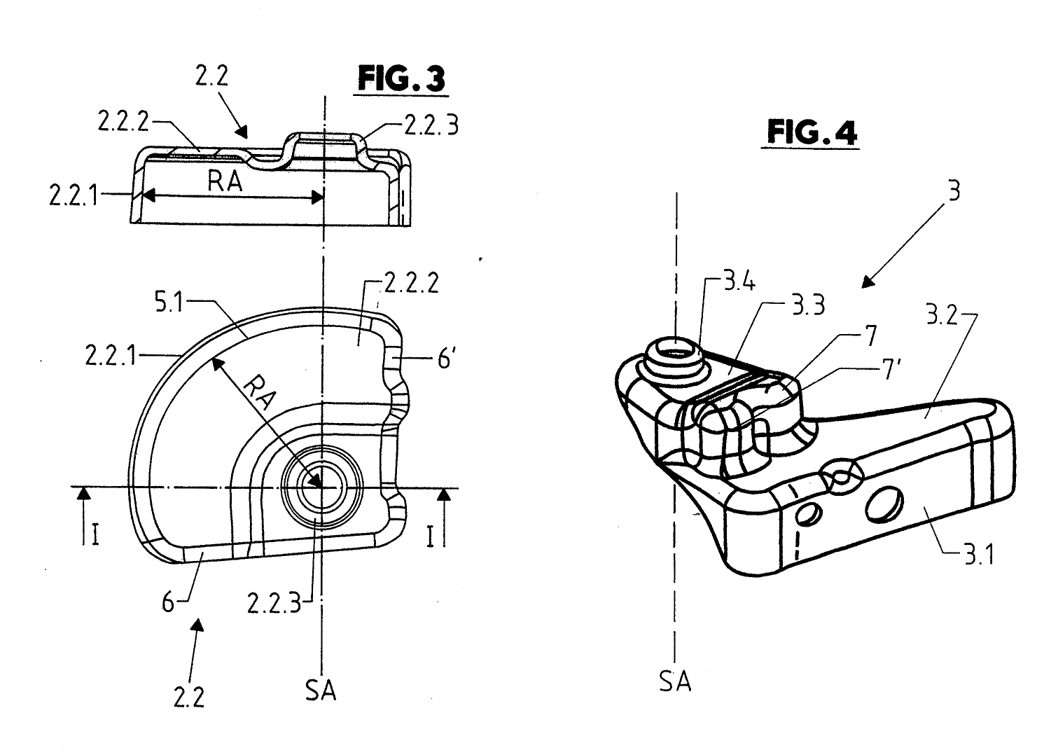

The first hinge wing 2 is at least partially dish-shaped and comprises one hinge plate 2.1 for fastening the first hinge wing 2 to a motor vehicle body and at least one hinge dish 2.2 firmly connected with the hinge plate 2.1. The hinge plate 2.1 can comprise several openings for receiving fastening means and an elongated recess for non-rotatable mounting of the hinge plate 2.1 on the motor vehicle body. Alternatively, the hinge plate 2.1 and the hinge dish 2.2 can be one piece. FIG. 3 shows a top view of the hinge dish 2.2 and a cross section along the plane I-I through the hinge dish 2.2.

The hinge dish 2.2 comprises a closed dish wall 2.2.1, a dish bottom 2.2.2 and a circular first connecting flange 2.2.3 which is concentric to the hinge axis SA. The first connecting flange 2.2.3 protrudes upward from the dish bottom 2.2.2 in the direction of the hinge axis SA and comprises a bore hole concentrically surrounding the hinge axis SA for receiving the hinge pin 4.

The dish wall 2.2.1 extends at least section-wise radially to the hinge axis SA, wherein the section of the dish wall 2.2.1 extending radially to the hinge axis SA is curved or arched relative to the hinge axis SA and has approximately the circumference of a quarter circle. The two edge areas of the curved section of the dish wall 2.2.1 respectively make the transition into an approximately straight wall section, wherein these sections enclose a right angle. The dish wall 2.2.1 can widen downward slightly starting from the dish bottom 2.2.2 in the direction of the hinge axis SA, i.e. it can enclose an acute angle with the hinge axis SA to form a “joining diagonal”. This “joining diagonal” enables the easy and precise mounting of the second hinge wing 3 in the first hinge wing 2.

The inner surface of the curved section of the dish wall 2.2.1 facing the hinge axis forms the braking surface 5.1 of the brake arrangement 5, whereas the two approximately straight wall sections form the door stop surfaces 6, 6′ of the motor vehicle hinge 1. The radial distance RA of the inner surface forming the braking surface 5.1 to the hinge axis SA can change along the periphery of the braking surface 5.1 and therefore between the two door stop surfaces 6, 6′, namely the degree of curvature of single circumferential sections of the braking surface 5.1 can be different.

The second hinge wing 3 is step-like and comprises a flat mounting section 3.1 which is provided for mounting the second hinge wing 3 on the motor vehicle door. In this design, the plane receiving the flat mounting section 3.1 extends approximately parallel to the hinge axis SA. FIG. 4 shows a perspective top view of the second hinge wing 3, wherein the step-like design is shown in FIG. 5.

The flat mounting section 3.1 is adjoined by a flat surface section 3.2, which encloses a right angle with the fastening section 3.1 and with the hinge axis SA. The side of the flat surface section 3.2 at a distance from the flat fastening section 3.1 is adjoined by a connecting section 3.3 having a partial dished shape which comprises a second connecting flange 3.4 protruding upward, i.e. in the direction of the hinge axis SA. The second connecting flange 3.4 in turn has a bore hole extending concentrically to the hinge axis SA for receiving the hinge pin 4.

In assembled state, the first hinge wing 2 is mounted onto the second hinge wing 3, so that the second connecting flange 3.4 engages from below into the hollow cylindrical recess formed by the first connecting flange 2.2.3 and is guided in said recess concentrically around the hinge axis SA. Both the first and second connecting flanges 2.2.3, 3.4 are surrounded by a ring-shaped groove, which in assembled state also interact with each other. Therefore, the surface of the connecting section 3.3 of the second hinge wing 3 bears at least partially against the bottom side of the dish bottom 2.2.2 of the first hinge wing 2. In this design the first and/or second connecting flanges 2.2.3, 3.4 comprise preferably in the contact area and/or in the area of the ring-shaped groove lubricating means or are provided with a self-lubricating coating in order to be able to adequately receive the torsional forces introduced in the area of the first and second connecting flange 2.2.3, 3.4.

The elastic brake body 5.2 is located between the outer dish wall of the second hinge wing 3 extending radially to the hinge axis SA and the braking surface 5.1. The elastic brake body 5.2 shown in a perspective top view in FIG. 6 has an approximately U- or C-shaped or horseshoe-shaped form and includes a brake body middle section 5.2.1 and two brake body leg sections 5.2.2, 5.2.3 laterally adjoining the latter.

The outer side 5.2′ of the elastic brake body 5.2 bears against the braking surface 5.1 and the inner side 5.2″ bears against the outer dish wall of the one partially dish-shaped connecting section 3.3 of the hinge wing 3. The outer side 5.2′ of the brake body middle section 5.2.1 is rounded in the area between the brake body middle section 5.2.1 and the respective adjoining brake body leg sections 5.2.2, 5.2.3. This avoids tilting of the elastic brake body 5.2 in case the braking surface 5.1 is overrun. Furthermore, the form of the transition area or its degree of rounding makes it possible to define the stop behavior of the brake arrangement 5 of the motor vehicle hinge 1. A suitable outward curvature in the transition area, results in two outer damper jaws which interact with the door stop surfaces 6, 6′ and therefore enable damped braking of the door in the stop position. The brake body 5.2 is manufactured from a stable, elastic plastic, or from an elastomer. As can be seen in FIG. 5 the elastic brake body 5.2 has an approximately rectangular cross section at least in the area of the brake body middle section 5.2.1. The outer side 5.2′ of the elastic brake body 5.2 is adapted in a preferred embodiment to the “joining diagonal” of the dish wall 2.2.1 of the first hinge wing 2.

On the inner side 5.2″ of the brake body 5.2, two slot-shaped recesses 8, 8′ are provided, which together with the brake body leg sections 5.2.2, 5.2.3 which partially encompass the connecting section 3.3 of the second hinge wing 3 in a clasp-like manner, enable the rotationally stable fastening of the elastic brake body 5.2 on the second hinge wing 3. The elastic brake body 5.2 is therefore connected by means of the inner side 5.2″ facing away from the braking surface 5.1 with the second hinge wing 3 in a form-fitting and solid manner, so that the outer side 5.2′ of the brake body 5.2 slides along the braking surface 5.1 during rotation of the first hinge wing 2 relative to the second hinge wing 3 around the hinge axis SA. In this design, the outer side 5.2′ of the elastic brake body 5.2 forms a friction surface with a pre-defined surface roughness, which can be provided with a special surface roughness profile.

FIG. 4 shows a perspective view of the top side of the second hinge wing 3 of the motor vehicle hinge 1 from which the step-like design, described above, becomes clear. The half dish-shaped connecting section 3.3 of the second hinge wing 3 comprises two projections 7, 7′, protruding from the hinge axis SA in a radial direction, which (projections) engage in the recesses 8, 8′. The projections 7, 7′ can be implemented as tongues stamped and bent out of the second hinge wing 3. FIG. 5 shows the described arrangement of the elastic brake body 5.2 between the braking surface 5.1 and the second hinge wing 3.

The inner side 5.2″ of the brake body 5.2 is formed by two concavely curved inner surface sections which are outwardly closed by the brake body leg sections 5.2.2, 5.2.3. The inner surface sections of the inner side 5.2′ of the elastic brake body 5.2 adapt to the support surfaces of the connecting section 3.3 surrounding the projections 7, 7′. The fastening of the elastic brake body 5.2 on the second hinge wing 3, described above, results in a nearly constant radial distance of the outer side 5.2′ of the elastic brake body 5.2 from the hinge axis SA, which, in the case of a decreasing radial distance RA of the braking surface 5.1 along the periphery, achieves clamping of the elastic brake body 5.2 between the first and second hinge wings 2, 3, wherein the amount of the friction or braking force provided by the brake arrangement 5 can be adjusted by means of the radial distance RA.

Furthermore, the path of the braking surface 5.1 is limited laterally by the door stop surfaces 6, 6′, so that—as can be seen in FIG. 7—the rotary movement of the second hinge wing 3 is limited by the striking of the brake body 5.2 on the door stop surfaces 6, 6′. The elastic design of the brake body 5.2 results in a soft, resilient striking on the door stops 6, 6′. In this design, the motor vehicle hinge 1 can assume any holding or braking positions between the one door stop surface 6 (“open position”) and the other door stop surface 6′ (“closed position”), wherein the friction or braking force generated by the brake arrangement 5 in pre-defined holding or braking positions can be constant or different. For example, the friction or braking force between the open position and the closed position can decrease in a linear manner or section-wise in a linear manner.

In a preferred embodiment, the braking surface 5.1 has a discontinuous, non-linear path, wherein the radial distance RA of the braking surface 5.1 to the hinge axis SA decreases as the angle of opening increases and is minimal in the open position, i.e. the braking effect increases as the angle of opening increases and reaches a maximum in the open position. Furthermore, the path of the braking surface 5.1 can have different degrees of curvature, i.e. it can be curved around further axes parallel to the hinge axis SA, namely in the edge areas of the dish wall 2.2.1.

Preferably the brake arrangement 5.1 comprises at least two braking surface sections, wherein the radial distance RA between the hinge axis SA and the braking surface sections of the braking surface 5.1 changes stepwise. For this purpose the braking surface 5.1 is sub-divided by means of a step-like shoulder in the braking surface 5.1 into at least two braking surface sections which have a different radial distance RA to the hinge axis SA. If the brake body 5.2 overruns the step-like shoulder during rotation of the first hinge wing 2 relative to the second hinge wing 3, the braking force generated by the brake arrangement 5 changes abruptly. Depending on the desired braking behavior the flanks of the step-like shoulder can be flattened or have a steep angle. Several consecutive step-like shoulders can be provided along the braking surface 5.1. Also, the radial distance RA within a braking surface section can be constant or variable, decreasing in a linear manner.

In an advantageous embodiment, the braking surface 5.1 comprises at least one step-like shoulder, which causes the braking force to increase abruptly in the open position of the motor vehicle hinge 1. This ensures secure holding of the motor vehicle door in the open position, in the case of unfavorable wind conditions or a steep road. It is further advantageous to entirely eliminate the braking force in an angle range immediately adjoining the closing position, especially in the range of the first 10° to 12°, starting from the closed position, which in no way unnecessarily hinders closing of the motor vehicle door by the brake arrangement 5.

In order to protect the motor vehicle hinge 1 from corrosion, since it is exposed to extreme weather conditions such as moisture and salt, and therefore also to keep the braking effect of the brake arrangement 5 approximately constant over the life of the vehicle, the motor vehicle hinge 1 is manufactured at least partially from corrosion-free material, for example, stainless steel. Alternatively, the motor vehicle hinge 1 can be provided entirely or partially with a corrosion-inhibiting coating. Furthermore, metal-cladding of the motor vehicle hinge 1 is possible for preventing corrosive effects.

The invention was described above based on exemplary embodiments. Numerous variations and modifications of the subject matter of the invention are possible without abandoning the underlying inventive concept.

### REFERENCE LIST

1 motor vehicle hinge
2 first hinge wing
2.1 hinge plate
2.2 hinge dish
2.2.1 dish wall
2.2.2 dish bottom
2.2.3 first connecting flange
3 second hinge wing
3.1 flat fastening section
3.2 flat surface section
3.3 connecting section
3.4 second connecting flange
4 hinge pin
5 brake arrangement
5.1 braking surface
5.2 brake body
5.2′ outer side
5.2″ inner side
5.2.1 brake body middle section
5.2.2 brake body leg section
5.2.3 brake body leg section
6, 6′ door stop surfaces
7, 7′ projections
8, 8′ recesses
SA hinge axis
RA radial clearance

1. A motor vehicle hinge comprising first and second hinge wings, and a hinge connecting the first and second hinge wings in a rotary movable manner around a hinge axis, a continuously variable brake arrangement, which comprises one braking surface provided at least section-wise radially to the hinge axis and at least one brake body interacting with the braking surface, wherein the brake body is provided radially at a distance from the hinge axis and is directly connected with the second hinge wing, wherein the braking surface is one piece with the first hinge wing.

2. The motor vehicle hinge according to claim 1, wherein a radial distance between the hinge axis and the braking surface along a periphery of the braking surface is constant or section-wise constant.

3. The motor vehicle hinge according to claim 1, wherein a radial distance between the hinge axis and the braking surface along a periphery of the braking surface is variable or section-wise variable.

4. The motor vehicle hinge according to claim 3, wherein the radial distance between a closed position and an open position of the motor vehicle hinge decreases in a linear manner or section-wise in a linear manner.

5. The motor vehicle hinge according to claim 1, wherein the motor vehicle hinge comprises at least two braking surface sections, wherein a radial distance between the hinge axis and the braking surface changes stepwise between the at least two braking surface sections.

6. The motor vehicle hinge according to claim 1, wherein the first hinge wing is at least partially dish-shaped with an at least partially curved dish wall surrounding the hinge axis, and wherein at least one curved section of the dish wall is continuously or discontinuously curved around the hinge axis.

7. The motor vehicle hinge according to claim 6, wherein the braking surface is at least partially formed by an inner surface of the curved section of the dish wall.

8. The motor vehicle hinge according to claim 6, wherein the braking surface is limited laterally by two door stop surfaces which are formed by sections of the dish wall of the first hinge wing, which sections respectively adjoin the curved section of the dish wall.

9. The motor vehicle hinge according to claim 8, wherein an outer side of the brake body interacts with the braking surface of the first hinge wing.

10. The motor vehicle hinge according to claim 9, wherein the outer side of the brake body is cylindrical or oval.

11. The motor vehicle hinge according to claim 1, wherein the brake body has an approximately U- or C-shaped basic form comprising a brake body middle section and brake body leg sections laterally adjoining the latter.

12. The motor vehicle hinge according to claim 11, wherein transition areas between the brake body middle section and the brake body leg sections are rounded.

13. The motor vehicle hinge according to claim 1, wherein an inner side of the brake body is fixed or fastened on the second hinge wing recesses provided on an inner side of the brake body middle section.

14. The motor vehicle hinge according to claim 13, wherein the second hinge wing comprises projections for fixing the brake body on the second hinge wing, the projections interact with the recesses of the brake body.

15. The motor vehicle hinge according to claim 1, wherein a braking force supplied by the continuously variable brake arrangement increases abruptly in the area of an open position of the motor vehicle hinge.

16. The motor vehicle hinge according to claim 1, wherein the continuously variable brake arrangement is inactive in an angle range smaller than 12°, adjoining a closed position.

17. The motor vehicle hinge according to claim 1, wherein the motor vehicle hinge, or parts of the motor vehicle hinge, or only the braking surface are manufactured from a corrosion-inhibiting material or are coated with such a material.

18. The motor vehicle hinge according to claim 1, wherein the motor vehicle hinge, or parts of the motor vehicle hinge, or only the braking surface are manufactured from stainless steel.

19. The motor vehicle hinge according to claim 1, wherein at least one of the first and second hinge wings is manufactured by deep drawing.

20. The motor vehicle hinge according to claim 1, wherein the brake body is elastically deformable, and is manufactured from a stable, elastic plastic, or from an elastomer.
